(19) United States
(12) Patent Application Publication
(10) Pub. No.: US 2026/0162465 A1
(43) Pub. Date: Jun. 11, 2026

(54) ELECTRIFIED VEHICLE RANGE ESTIMATION

(71) Applicant: FCA US LLC, Auburn Hills, MI (US)

(72) Inventors: Abhilash Gudapati, Auburn Hills, MI (US); Venkatasubramanian Sankara Raman, Auburn Hills, MI (US)

(21) Appl. No.: 18/976,697

(22) Filed: Dec. 11, 2024

(51) Int. Cl. G07C 5/00; B60L 50/60; B60L 58/12; B60L 58/16; G07C 5/04; H01M 10/48

(52) U.S. Cl. CPC G07C 5/004; B60L 50/60; B60L 58/12; B60L 58/16; G07C 5/04; H01M 10/48; H01M 10/486; H01M 10/488; H01M 2220/20

(57) ABSTRACT

A range estimation system for an electrified vehicle having a high voltage (HV) battery system includes a controller. The controller is configured to determine an initial estimated vehicle electric range based on data from a previous drive cycle, receive data from the HV battery system indicating status information of the HV battery system utilized to estimate a vehicle electric range, and determine if a power limitation is requested by the HV battery system. The controller further configured to determine if the initial estimated vehicle electric range is less than a predefined critical drivable threshold, and determine if the received data from the HV battery system is valid data or invalid data for the electric range calculation. An updated estimated vehicle electric range is then determined based on the received data, the power limitation request, and the validity of the received data from the HV battery system.

### FIELD

The present application generally relates to electrified vehicles and, more particularly, to range prediction or estimation techniques for electrified vehicles.

### BACKGROUND

Electrified vehicles include at least one electric traction motor powered by a high voltage battery system, which is capable of storing a finite amount of energy. Range anxiety is a driver's perception of the risk of running out of propulsive or traction energy, and remains a key obstacle in the way of wide marketability of electrified vehicles. A key contributor to range anxiety is inaccuracy and variability of the displayed remaining range. Conventional range estimation techniques may help reduce range anxiety, but such conventional techniques may provide inaccurate estimations, particularly when vehicle faults or power limitations are present. Accordingly, while such conventional electrified vehicle range estimation techniques do work for their intended purpose, there exists an opportunity for improvement in the relevant art.

### SUMMARY

According to one example aspect of the invention, a range estimation system for an electrified vehicle having an electrified powertrain including an electric motor powered by a high voltage (HV) battery system is provided. In one exemplary implementation, the system includes a controller having one or more processors and a non-transitory computer-readable storage medium having a plurality of instructions stored thereon, which, when executed by the one or more processors, cause the one or more processors to perform operations comprising: determine an initial estimated vehicle electric range based on data from a previous drive cycle; receive data from the HV battery system indicating status information of the HV battery system utilized to estimate a vehicle electric range; determine if a power limitation is requested by the HV battery system; determine if the initial estimated vehicle electric range is less than a predefined critical drivable threshold; determine if the received data from the HV battery system is valid data or invalid data for the electric range calculation; determine a first updated estimated vehicle electric range based on the received data from the HV battery system, if (i) the power limitation is requested and (ii) the initial estimated vehicle electric range is greater than the critical drivable threshold; and determine a second updated estimated vehicle electric range based on the received data from the HV battery system, if (i) the initial estimated vehicle electric range is less than the critical drivable threshold and (ii) the received data is valid.

In addition to the foregoing, the described system may include one or more of the following features: wherein the received data includes a state of charge (SOC) of the HV battery system, a state of health (SOH) of the HV battery system, a temperature of the HV battery system, and a capacity and voltage of the HV battery system; and wherein the first updated estimated vehicle electric range is determined based on the received data and a total electrical energy being consumed by the electrified vehicle per a distance driven, and wherein the second updated estimated vehicle electric range is determined based on (i) the received data from the HV battery system in view of a maximum usable HV battery capacity and the predefined power limit and (ii) the total electrical energy being consumed by the electrified vehicle per the distance driven.

In addition to the foregoing, the described system may include one or more of the following features: wherein the first and second updated estimated vehicle electric ranges are further determined based on one or more modification factors based on vehicle performance characteristics; wherein the controller is further configured to display the first and/or second updated estimated vehicle electric ranges on a human machine interface (HMI) of the electrified vehicle, and blink the displayed first and/or second updated estimated vehicle electric ranges; and wherein the controller is further configured to increase a blink rate of the displayed first and/or second updated estimated vehicle electric ranges as the estimated vehicle electric range decreases.

In addition to the foregoing, the described system may include one or more of the following features: wherein the controller is further configured to determine a last known valid data from the HV battery system, if the received data includes invalid data, and determine a third updated estimated vehicle electric range based on the last known valid data from the HV battery system in view of a maximum usable HV battery capacity and a predefined power limit, if the received data includes invalid data; and wherein the power limitation request is due to hardware limitations and/or temperature constraints.

In accordance with another example aspect of the invention, a range estimation system for an electrified vehicle having an electrified powertrain including an electric motor powered by a high voltage (HV) battery system is provided. In one exemplary implementation, the system includes a controller having one or more processors and a non-transitory computer-readable storage medium having a plurality of instructions stored thereon, which, when executed by the one or more processors, cause the one or more processors to perform operations comprising: determine an initial estimated vehicle electric range based on data from a previous drive cycle; receive data from the HV battery system indicating status information of the HV battery system utilized to estimate a vehicle electric range; determine if the received data from the HV battery system is valid data or invalid data for the electric range calculation; determine a last known valid data from the HV battery system, if the received data is invalid data; determine a first updated estimated vehicle electric range based on the received data from the HV battery system, if the received data is valid; and determine a second updated estimated vehicle electric range based on the last known valid data from the HV battery system, if the received data is invalid data.

In addition to the foregoing, the described system may include one or more of the following features: wherein the received data includes a state of charge (SOC) of the HV battery system, a state of health (SOH) of the HV battery system, a temperature of the HV battery system, and a capacity and voltage of the HV battery system; wherein the first updated estimated vehicle electric range is determined based on the received data and a total electrical energy being consumed by the electrified vehicle per a distance driven, and wherein the second updated estimated vehicle electric range is determined based on (i) the last known valid data from the HV battery system in view of a maximum usable HV battery capacity and a predefined power limit and (ii) the total electrical energy being consumed by the electrified vehicle per the distance driven.

In addition to the foregoing, the described system may include one or more of the following features: wherein the first and second updated estimated vehicle electric ranges are further determined based on one or more modification factors based on vehicle performance characteristics; wherein the controller is further configured to display the first and/or second updated estimated vehicle electric ranges on a human machine interface (HMI) of the electrified vehicle, and blink the displayed first and/or second updated estimated vehicle electric ranges; and wherein the controller is further configured to increase a blink rate of the displayed first and/or second updated estimated vehicle electric ranges as the estimated vehicle electric range decreases.

In addition to the foregoing, the described system may include one or more of the following features: wherein the controller is further configured to determine if a power limitation is requested by the HV battery system, determine if the initial estimated vehicle electric range is less than a critical drivable threshold, determine a third updated estimated vehicle electric range based on the received data from the HV battery system, if (i) the power limitation is requested and (ii) the initial estimated vehicle electric range is greater than the critical drivable threshold, and determine a fourth updated estimated vehicle electric range based on the received data from the HV battery system, if (i) the initial estimated vehicle electric range is less than the critical drivable threshold and (ii) the received data is valid data; and wherein the power limitation request is due to hardware limitations and/or temperature constraints.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example range estimation system according to the principles of the present application;

FIG. 2 is a flow diagram of an example range estimation method for an electrified vehicle, according to the principles of the present application; and

FIGS. 3A-3B illustrate a flow diagram of another example range estimation method for an electrified vehicle, according to the principles of the present application.

### DESCRIPTION

As previously discussed, high voltage battery systems are limited to storing a finite amount of energy, and the corresponding range anxiety remains a key obstacle in the way of wide marketability of electrified vehicles. A key contributor to range anxiety is inaccuracy and variability of the displayed remaining range. While conventional range estimation techniques may help reduce range anxiety, they are often inaccurate, particularly when vehicle faults or power limitations are present. The electrified powertrain and, more specifically, the electric traction motor(s), take the largest share of the energy consumption.

Predicting the energy consumption of the electrified powertrain often requires knowledge of vehicle acceleration, speed, vehicle weight and road topology, etc., but vehicle acceleration and speed can vary instantaneously and are generally unpredictable. In addition, factors such as road congestion and ambient conditions can significantly affect the energy consumption of the propulsion system. Similarly, determining the remaining energy of the high voltage battery system of the electrified vehicle incurs various challenges, which are mostly associated to determining the remaining energy of the battery. In contrast, determining the remaining energy in the form of stored liquid fuel (in the case of hybrid electric vehicles, or HEVs, having an internal combustion engine) or in the form of stored hydrogen (in the case of fuel cell electric vehicles, or FCEVs) is typically more straightforward.

In the systems described herein, estimated range is an indication of the distance the vehicle can be expected to be driven using only electric power, electric power with a gasoline/diesel engine power source, or electric power with hydrogen fuel cell power. The electric power calculation is based on the battery inputs, such as state of charge (SOC), battery capacity, battery temperature, and the energy being used per distance traveled. At start-up, the estimated range is based on the calculated range from the previous drive cycle, saved to memory. The energy being used in the current drive cycle is then calculated and is included as a factor in the estimated range. Factors that can affect the energy consumption are vehicle energy consumption (HVAC system, 12V loads, etc.), vehicle speed, drive mode selected, the amount of regenerative braking, and any other systems/events pull energy from or put energy into the high voltage (HV) battery.

For vehicles with fuel engines for range extension, the range calculation is based on equivalent electric-fuel energy remaining in the fuel tank, measured in Watt*Hours remaining, instantaneous fuel consumption, engine speed, and torque output. For vehicles with hydrogen fuel cells for range extension, the range calculation is based on equivalent hydrogen level, actual power produced by the fuel cell system, and actual hydrogen consumption. The overall range function can use many vehicle performance characteristics such as drag coefficient, vehicle mass, drive modes, etc. to determine the overall range of the vehicle.

Moreover, there may be inconsistency in electrified vehicle range due to degraded HV battery pack performance. “Power limits” is an input provided by the HV battery pack on its capability to charge or discharge. This is essentially, the amount of power that it can discharge for driving or other vehicle loads, or the amount of power it can receive while plug-in charging the vehicle via electric vehicle supply equipment or regeneration. The electric power calculation uses HV battery SOC and state of health (SOH), battery capacity, energy consumed (all high/low voltage loads), and power used for distance traveled to thereby calculate estimated range before factoring in the vehicle performance characteristics.

In some cases, failures cause the HV battery pack to transmit unreliable information of the SOC, SOH, battery temperature, battery capacity (e.g., invalid/unreliable sensor input), and/or battery discharge power limits (e.g., hardware limitation, temperature constraints). Such failures may cause the range estimation logic to enter a safe state of not showing any value as the unpredictability is extremely high on how long the vehicle can be driven. Such scenarios may put the vehicle in a limp home mode with an indication (e.g., turtle icon) and/or critical failure human machine interface (HMI) alerting the driver to drive to the nearest dealership. However, due to the lack of range information, the driver may be unaware of how far they can drive.

The HV battery pack can also enter a limp home state due to lower/restricted power limit states, which can be caused due to extreme temperatures with a low or extremely low state of charge, where the HV battery pack limits its discharge power to avoid component damage. In case of temperature causing power limits to be degraded, the battery pack SOC may be in an acceptable range, which could confuse the operator if there is no range displayed or an incorrect range is shown. In a case where battery pack faults lead to degraded power limits, the incorrect or missing range may be displayed, which can cause driver confusion.

Accordingly, improved range estimation techniques for electrified vehicles are presented herein. In general, these improved techniques are configured to provide a realistic vehicle range when invalid data is sent by the HV battery system or when the HV battery system has a power limitation. The techniques utilize information from the propulsion supervisory controller to estimate vehicle range. If a power limitation is requested by the HV battery system, further action is taken based off whether the current estimated electric range is above or below a critical drivable threshold (e.g., a threshold where the vehicle may be close to having to shut down or cease driving). If the HV battery system sends invalid data, the propulsion supervisory controller freezes the last known valid HV battery system information for further range estimation.

In one example, once the propulsion supervisory controller wakes up, an initial estimated range is based on the calculated range from the previous drive cycle, saved to memory. If the supervisory controller receives all information from the HV battery system (e.g., all expected inputs are valid) and there is no power limitation, then the propulsion system can continue with the normal existing range estimation logic with the following inputs: (i) HV battery SOC, SOH, temperature, and capacity, (ii) energy consumed (all vehicle loads - high and low voltage), (iii) energy and power used for distance traveled, and (iv) factored vehicle performance characteristics (e.g., drag coefficient, vehicle mass, drive mode).

If there is a power limitation requested by the HV battery system, the propulsion supervisory controller sets an internal maximum usable capacity and predefined power limits for driving and vehicle loads. In one example, the maximum usable capacity is a predefined capacity based on historical data and how much energy is going to be used to put the vehicle in a safe driving state.

In one example, the predefined power limits are a system decision to enter a limited mode of operation based on a min/max limit to ensure safe drivability. For example, the system limits the vehicle performance (e.g., based on remaining distance to empty) to ensure the driver understands the performance is limited and must recharge the vehicle (e.g., plug-in the EVSE to the vehicle for recharging (low SOC) or conditioning (power limitation). This may be due to low SOC or even due to power limitation. The range is calculated using all existing inputs from the HV battery system that are valid (e.g., invalid inputs are not used). This is because all the inputs from the HV battery system are expected to be valid, and if there is no power limitation request, the existing range calculation will be realistic.

However, if the current estimated electric range is above the critical drivable threshold, the range is calculated based on all valid existing inputs (e.g., from the HV battery system). If the current estimated electric range is below the critical drivable threshold and if the HV battery system sends invalid data due to internal reasons (e.g., communication issues, inconsistent sensor feedback), the propulsion supervisory controller freezes/holds the last known valid information from the HV battery system. The propulsion supervisory controller then performs the range estimation based on the following: (i) propulsion supervisory controller internal maximum usable capacity and predefined power limits for driving and vehicle loads, (ii) energy and power used for distance traveled utilizing the frozen last known valid information from the HV battery pack, and (iii) factored vehicle performance characteristics.

Finally, in all system inefficiency scenarios when electric range is calculated, the propulsion supervisory controller is configured to display a blinking estimated electric range value to alert the driver. The rate of blinking occurs based on various factors such as, for example, calculated remaining range, and energy and power used for distance traveled. The blinking rate may be dependent on the rate of change in estimated range, with the blinking rate being higher for a faster range decrease, and a slower blinking rate for a slower range decrease.

In one example scenario, the HV battery system has a power limitation and the vehicle range is not within the critical drivable threshold. With the use of new inputs such as maximum usable capacity and predefined power limits for driving the vehicle loads, the vehicle range can be recalculated without the battery inputs that may show a false higher range. As such, a realistic range value can be calculated when system inefficiencies exist, because the driver may not be able to drive the distance that was previously shown before the inefficient state.

In another example scenario, the HV battery system provides invalid values. The system then utilizes the last known correct values, and then utilizes the maximum usable capacity and predefined power limits for driving and vehicle loads, and the energy and power used for the distance traveled. The system subsequently rationalizes the information with the last known correct values to estimate the energy and power remaining, to thereby calculate an accurate range.

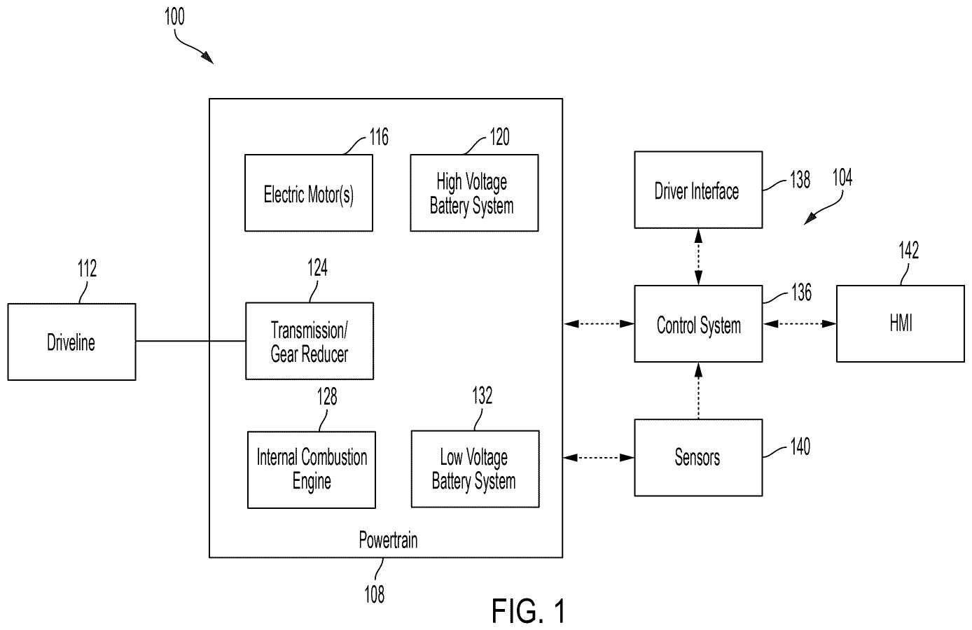

With initial reference to FIG. 1, a functional block diagram of an electrified vehicle 100 having an example range estimation system 104 according to the principles of the present application is illustrated. The electrified vehicle 100 could be any suitable type of electrified vehicle, including, but not limited to, battery electric vehicle (BEV) or a hybrid electric vehicle (HEV). The electrified vehicle 100 comprises an electrified powertrain 108 configured to generate and transfer drive torque to a driveline 112 for vehicle propulsion. The electrified powertrain 108 includes one or more electric traction motors 116 each configured to generate mechanical drive torque using energy (e.g., electrical current) supplied by a high voltage (HV) battery system 120. For example, an inverter (not shown) could be used to convert the direct current (DC) from the high voltage battery system 120 to three-phase alternating current (AC) to power the electric traction motor(s) 116. A transmission 124 (e.g., an automatic transmission) is configured to transfer the drive torque from the electrified powertrain 108 to the driveline 112.

In some configurations, the electrified powertrain 108 may also include an internal combustion engine 128 configured to combust a mixture of air and fuel (gasoline, diesel, etc.) to generate mechanical torque for vehicle propulsion and/or conversion to electrical energy, such as for recharging battery system 120. It will be appreciated that the electrified powertrain 108 could alternatively include another energy generator, such as a hydrogen or other suitable fuel cell system (a fuel cell electric vehicle, or FCEV). A low voltage battery system 132 (e.g., a 12-volt (V) battery) is configured to power low voltage components and accessory loads of the electrified vehicle 100.

A control system 136 is configured to control the electrified powertrain 108, including controlling the electrified powertrain to generate an amount of drive torque to satisfy a torque request provided by a driver/operator via a driver interface 138 (e.g., an accelerator pedal). A plurality of sensors 140 are configured to measure operating parameters of the electrified vehicle 100, such as, but not limited to, speeds/accelerations, pressures, temperatures, and electrical parameters (voltage, current, state of charge, etc.). The sensors 140 may also include other vehicle systems, such as a GPS navigation/maps system. The control system 136 is also in signal communication with a human machine interface (HMI) 142 such as, for example, an instrument panel cluster or other display, configured to display information to the driver.

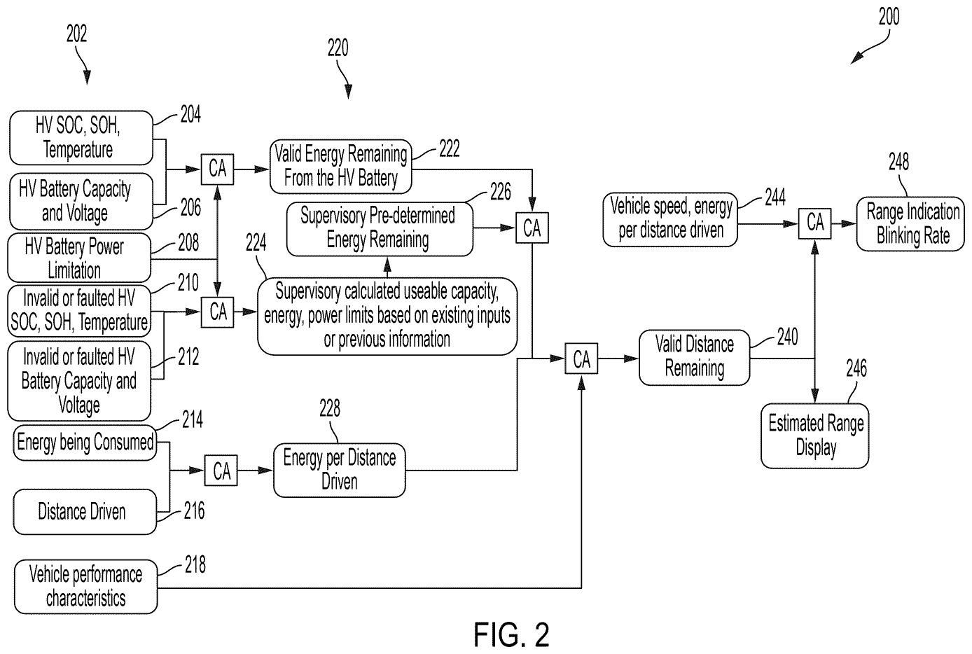

Referring now to FIG. 2, a flow diagram of an example range estimation method 200 for an electrified vehicle according to the principles of the present application is illustrated. While the method 200 specifically references the electrified vehicle 100 and its components for illustrative/descriptive purposes, it will be appreciated that the method 200 could be applicable to any suitably configured electrified vehicle.

In the example embodiment, the method begins at 202 and the powertrain supervisory controller 136 (“control”) receives status information from the HV battery system 120. In particular, control receives various inputs for estimating the range of vehicle 100. A first input 204 indicates the HV battery SOC, SOH, and temperature. A second input 206 indicates the HV battery capacity and voltage. A third input 208 indicates if limited power is available (e.g., there is a power limitation set by HV battery system 120). A fourth input 210 indicates if an invalid or faulted input is detected for the HV battery SOC, SOH, or temperature. A fifth input 212 indicates if an invalid or faulted input is detected for the HV battery capacity and voltage. A sixth input 214 indicates an amount of electrical energy being consumed by the vehicle 100. A seventh input 216 indicates a distance driven by the vehicle 100. An eighth input 218 indicates vehicle specific performance characteristics such as, for example, drag coefficient, vehicle mass, drive mode, etc.

At 220, control evaluates or utilizes the inputs from step 202, for example, using a control algorithm (CA). In particular, at 222, control utilizes the first, second, and third inputs 204, 206, 208 to determine a valid electrical energy remaining from the HV battery system 120 based on external inputs. At 224, control utilizes the third, fourth, and fifth inputs 208, 210, 212 to determine a supervisory controller calculated usable HV battery capacity, energy, and power limits based on existing inputs or previous information. At 226, control determines a supervisory predetermined energy remaining.

At 228, control utilizes the sixth and seventh inputs 214, 216 to determine the amount of electrical energy consumed per the driven distance. Additionally, control utilizes the eighth input 218 to determine one or more modification factors based on the vehicle performance characteristics.

At 240, if the input data from the HV battery system 120 is valid, control utilizes the valid energy remaining based on external inputs (222) and the energy per distance driven (228) to determine a valid distance remaining. However, if data from the HV battery system 120 is invalid or faulted, control utilizes the supervisory predetermined energy remaining (226) and the energy per distance driven (228) to determine a supervisory controller calculated distance remaining. At 244, control determines the vehicle speed and energy consumed per the distance driven.

At 246, control utilizes the valid distance remaining (240) to determine an estimated vehicle range remaining, which is then displayed to the driver. At 248, for faulted/invalid HV battery system data, control utilizes the valid distance remaining (240) and the vehicle speed and energy per distance driven (244) to determine a range indication blinking rate to be displayed to the driver.

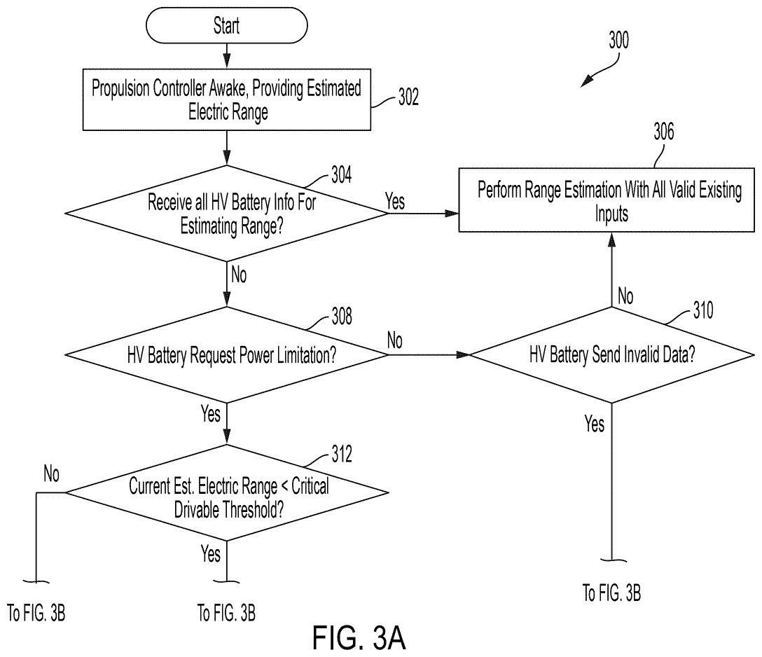

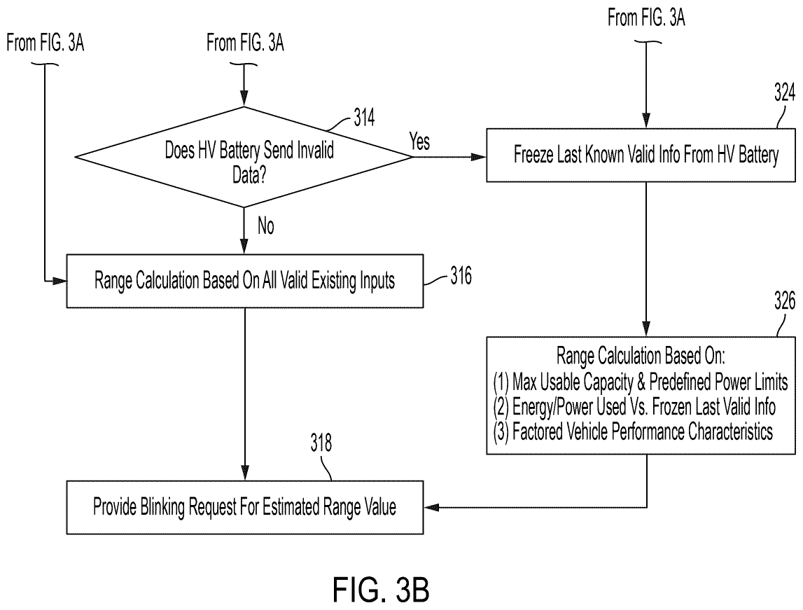

Referring now to FIGS. 3A-3B, a flow diagram of an example range estimation method 300 for an electrified vehicle according to the principles of the present application is illustrated. While the method 300 specifically references the electrified vehicle 100 and its components for illustrative/descriptive purposes, it will be appreciated that the method 300 could be applicable to any suitably configured electrified vehicle.

In the example embodiment, the method begins at 302 where, upon wakeup, the propulsion supervisory controller 136 (“control”) provides an initial estimated electric range for vehicle 100. At 304, control receives status information/data from the HV battery system 120 and subsequently determines if all required information/data is present in order to perform an estimated electric range calculation. In other words, control determines if all the information received is ‘valid’. If yes, control proceeds to 306 and estimates the vehicle electric range based on “all valid existing inputs” (e.g., (i) HV battery SOC, SOH, temperature, capacity, (ii) energy consumed by all HV/LV vehicle loads, (iii) energy and power used for distance traveled, and (iv) factored vehicle performance factors). If no, control proceeds to 308 and determines if the HV battery system 120 is requesting a power limitation. If no, control proceeds to 310. If yes, control proceeds to 312.

At 310, control determines if the HV battery system 120 has sent invalid data for the vehicle electric range estimation. If no, control proceeds to 306 and operates as previously described. If yes, control proceeds to 324, which will be described in more detail.

At 312, control determines if the current estimated vehicle electric range (e.g., from step 302 or an instantaneous range) is below a critical drivable threshold. In one example, the critical drivable threshold is a predetermined threshold range (or SOC) that would enable a driver to reach a charging location with the remaining range (e.g., a “low fuel” threshold). If yes, control proceeds to 314. If no, control proceeds to 316.

At 314, control determines if the HV battery system 120 has sent invalid data for the electric range calculation. If no, control proceeds to 316. If yes, control proceeds to 324.

At 316, control estimates a new/updated vehicle electric range based on “all valid existing inputs” and provides the information to the HMI 142 (e.g., an instrument panel cluster) for display to the driver. At 318, control may also provide a request to “blink” the displayed estimated vehicle electric range (316) at a predetermined rate. The predetermined blink rate may be based on, for example, the estimated remaining electric range, the vehicle speed for distance traveled, and/or energy and power used for the distance traveled.

Returning to 324, if control determines the HV battery system 120 has sent invalid data for the vehicle electric range estimation, control obtains/freezes the last known valid information from the HV battery system 120. At 326, control utilizes the last known valid information to estimate a new/updated vehicle electric range based on: (i) the propulsion supervisory controller 136 internal maximum usable capacity and predefined power limits for driving and vehicle loads, (ii) energy and power used for the distance traveled using the frozen last known valid information from the HV battery system 120, and (iii) factored vehicle performance characteristics. Control then provides the new/updated estimated vehicle electric range for display to the driver. Control then proceeds to 318 and provides the predetermined blink rate, as previously described. The method may then end or return to 302.

It will be appreciated that the term “controller” or “module” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A range estimation system for an electrified vehicle having an electrified powertrain including an electric motor powered by a high voltage (HV) battery system, the range estimation system comprising:
a controller having one or more processors and a non-transitory computer-readable storage medium having a plurality of instructions stored thereon, which, when executed by the one or more processors, cause the one or more processors to perform operations comprising:
determine an initial estimated vehicle electric range based on data from a previous drive cycle;
receive data from the HV battery system indicating status information of the HV battery system utilized to estimate a vehicle electric range;
determine if a power limitation is requested by the HV battery system;
determine if the initial estimated vehicle electric range is less than a predefined critical drivable threshold;
determine if the received data from the HV battery system is valid data or invalid data for the electric range calculation;
determine a first updated estimated vehicle electric range based on the received data from the HV battery system, if (i) the power limitation is requested and (ii) the initial estimated vehicle electric range is greater than the critical drivable threshold; and
determine a second updated estimated vehicle electric range based on the received data from the HV battery system, if (i) the initial estimated vehicle electric range is less than the critical drivable threshold and (ii) the received data is valid.

2. The range estimation system of claim 1, wherein the received data comprises:
a state of charge (SOC) of the HV battery system;
a state of health (SOH) of the HV battery system;
a temperature of the HV battery system; and
a capacity and voltage of the HV battery system.

3. The range estimation system of claim 2, wherein the first updated estimated vehicle electric range is determined based on the received data and a total electrical energy being consumed by the electrified vehicle per a distance driven, and
wherein the second updated estimated vehicle electric range is determined based on (i) the received data from the HV battery system in view of a maximum usable HV battery capacity and the predefined power limit and (ii) the total electrical energy being consumed by the electrified vehicle per the distance driven.

4. The range estimation system of claim 3, wherein the first and second updated estimated vehicle electric ranges are further determined based on one or more modification factors based on vehicle performance characteristics.

5. The range estimation system of claim 1, wherein the controller is further configured to:
display the first and/or second updated estimated vehicle electric ranges on a human machine interface (HMI) of the electrified vehicle; and
blink the displayed first and/or second updated estimated vehicle electric ranges.

6. The range estimation system of claim 5, wherein the controller is further configured to increase a blink rate of the displayed first and/or second updated estimated vehicle electric ranges as the estimated vehicle electric range decreases.

7. The range estimation system of claim 1, wherein the controller is further configured to:
determine a last known valid data from the HV battery system, if the received data includes invalid data; and
determine a third updated estimated vehicle electric range based on the last known valid data from the HV battery system in view of a maximum usable HV battery capacity and a predefined power limit, if the received data includes invalid data.

8. The range estimation system of claim 1, wherein the power limitation request is due to hardware limitations and/or temperature constraints.

9. A range estimation system for an electrified vehicle having an electrified powertrain including an electric motor powered by a high voltage (HV) battery system, the range estimation system comprising:
a controller having one or more processors and a non-transitory computer-readable storage medium having a plurality of instructions stored thereon, which, when executed by the one or more processors, cause the one or more processors to perform operations comprising:
determine an initial estimated vehicle electric range based on data from a previous drive cycle;
receive data from the HV battery system indicating status information of the HV battery system utilized to estimate a vehicle electric range;
determine if the received data from the HV battery system is valid data or invalid data for the electric range calculation;
determine a last known valid data from the HV battery system, if the received data is invalid data;
determine a first updated estimated vehicle electric range based on the received data from the HV battery system, if the received data is valid; and
determine a second updated estimated vehicle electric range based on the last known valid data from the HV battery system, if the received data is invalid data.

10. The range estimation system of claim 9, wherein the received data comprises:
a state of charge (SOC) of the HV battery system;
a state of health (SOH) of the HV battery system;
a temperature of the HV battery system; and
a capacity and voltage of the HV battery system.

11. The range estimation system of claim 10, wherein the first updated estimated vehicle electric range is determined based on the received data and a total electrical energy being consumed by the electrified vehicle per a distance driven, and
wherein the second updated estimated vehicle electric range is determined based on (i) the last known valid data from the HV battery system in view of a maximum usable HV battery capacity and a predefined power limit and (ii) the total electrical energy being consumed by the electrified vehicle per the distance driven.

12. The range estimation system of claim 11, wherein the first and second updated estimated vehicle electric ranges are further determined based on one or more modification factors based on vehicle performance characteristics.

13. The range estimation system of claim 9, wherein the controller is further configured to:
display the first and/or second updated estimated vehicle electric ranges on a human machine interface (HMI) of the electrified vehicle; and
blink the displayed first and/or second updated estimated vehicle electric ranges.

14. The range estimation system of claim 13, wherein the controller is further configured to increase a blink rate of the displayed first and/or second updated estimated vehicle electric ranges as the estimated vehicle electric range decreases.

15. The range estimation system of claim 9, wherein the controller is further configured to:
determine if a power limitation is requested by the HV battery system;
determine if the initial estimated vehicle electric range is less than a critical drivable threshold; and
determine a third updated estimated vehicle electric range based on the received data from the HV battery system, if (i) the power limitation is requested and (ii) the initial estimated vehicle electric range is greater than the critical drivable threshold.

16. The range estimation system of claim 15, wherein the controller is further configured to:
determine a fourth updated estimated vehicle electric range based on the received data from the HV battery system, if (i) the initial estimated vehicle electric range is less than the critical drivable threshold and (ii) the received data is valid data.

17. The range estimation system of claim 15, wherein the power limitation request is due to hardware limitations and/or temperature constraints.
